(19) United States
(12) Patent Application Publication
(10) Pub. No.: US 2007/0252812 A1
(43) Pub. Date: Nov. 1, 2007

(54) Method for Visually Representing Personality Type

(75) Inventor: Cash Keahey, Richardson, TX (US)

Correspondence Address: CONLEY ROSE, P.C., 5601 GRANITE PARKWAY, SUITE 750, PLANO, TX, 75024, US

(73) Assignee: Cash Keahey, Richardson, TX (US)

(21) Appl. No.: 11/572,194

(22) PCT Filed: Jul. 21, 2004
(86) PCT No.: PCT/US04/23564

§ 371 Date: Jun. 28, 2007

(51) Int. Cl. G09G 5/00

(52) U.S. Cl. 345/156

(57) ABSTRACT

An icon for indicating a person's personality type and a method for creating an icon that visually represents a person's personality type are disclosed. The personality type may be defined by the Myers-Briggs Type Indicator (MBTI). The method comprises selecting a shape based on the person's preferred approach to the world: a circle for a Perceiving preference and a square for a Judging preference. A vertical line is placed in the shape if the person is an Introvert and a horizontal line is place in the shape if the person is an Extravert. Colors are then filled into the two sections of the shape based on the person's mental functions: blue for iNtuitive, green for Sensing, red for Feeling, and black for Thinking. The resulting icon is specific to the person's personality type and is a memorable visual reference.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The theory that people have psychological types was developed by psychiatrist Carl Jung in the early twentieth century. Jung theorized that random behavior is actually the result of differences in the way individuals prefer to use their mental capacities. His theory proposes that people prefer to view the world in one of two ways: perceiving or judging. Perceiving is the act of taking in information, and judging is the act of organizing information. Jung also proposed that the way people take in information can be categorized as either sensing or intuitive. Similarly, Jung proposed that people make decisions based either on logic or feelings. Finally, Jung theorized that people are energized either by the external world or by the internal world; i.e. people are either extraverts or introverts. Jung called a person's preference in each of these categories their psychological type. In 1922, Jung published Psychological Types to describe his observations and introduce the idea that each person has a psychological type. Later, Isabel Briggs Myers and Katherine Briggs developed a method for determining a person's personality type called the Myers-Briggs Type Indicator® (MBTI). Today, the MBTI is one of the most widely accepted personality type indicators in the world.

The MBTI categorizes a person's personality type into attitudes and mental functions. The attitudes describe how a person relates to the external world, and there are two attitudes: approach to the world and energy attitude. A person has a preference for either a Judging or Perceiving approach to the world. A person also has a preference for either an Introverted or Extraverted energy attitude. The mental functions describe how a person processes information in his/her mind. There are two mental functions: the method for taking in information and the method for making decisions. A person has a preference for either a Sensing or iNtuitive method for taking in information. A person also has a preference for either a Thinking or a Feeling method for making decisions.

Under the MBTI format, a person's personality type is described by a four letter code, wherein each letter represents the person's energy attitude, method for taking in information, method for making decisions, and approach to the world, respectively. For each letter, there are two possibilities. Table 1 below illustrates the possible personality types:

TABLE 1

| Letter | Attitude/Mental | | |
|---|---|---|---|
| Position | Function | Preference | Description |
| First letter | Energy attitude | Introverted (I) | Prefer the inner world of ideas and |
| | | | images |
| | | Extraverted (E) | Prefer the outer world of people and |
| | | | things |
| Second letter | Method for taking in | Sensing (S) | Prefer information gathered through |
| | information | | the five senses |
| | | Intuitive (N) | Prefer information gathered from |
| | | | patterns and meanings |
| Third letter | Method for making | Thinking (T) | Prefer basing decisions on objective |
| | decisions | | principles and facts |
| | | Feeling (F) | Prefer basing decisions on subjective |
| | | | human concerns and feelings |
| Fourth letter | Approach to the | Judging (J) | Prefer structure and order |
| | world | | |
| | | Perceiving (P) | Prefer flexibility and adaptability |

Thus, there are sixteen Myers-Briggs personality types: ISTJ, ISTP, ISFJ, ISFP, INTJ, INTP, INFJ, INFP, ESTJ, ESTP, ESFJ, ESFP, ENTJ, ENTP, ENFJ, and ENFP.

One of the problems with the Myers-Briggs personality type format is that the four letter code is difficult to remember. In order to recall their personality type, a person is required to make the following series of mental connections: remember the specific four letters for their personality type, associate each of the four letters with the particular preference that the letter is an abbreviation for, and recall the traits associated with each of the four preferences. This series of mental connections is challenging and difficult for most people. Thus, people either remember the wrong personality type or cannot recall any personality type. Tests indicate that people are better at recalling things that are personal and/or meaningful to them. The MBTI four-letter personality type format is not likely to be personal or meaningful to most people. Consequently, a need exists for a method of making a personality type more personal and meaningful so that people can recall their personality type.

### SUMMARY

An icon for indicating a person's personality type, and a method for creating an icon that visually represents a person's personality type are disclosed. In an embodiment, the personality type is defined by the Myers-Briggs Type Indicator (MBTI). The method involves selecting a shape based on the person's preferred approach to the world. In an embodiment, a circle is selected for a Perceiving preference and a square is selected for Judging preference. The method further comprises placing a vertical line within the shape if the person is an Introvert and placing a horizontal line within the shape if the person is an Extravert. The line thereby divides the shape into two sections, either left and right sections or upper and lower sections, depending upon the type of line placed within the shape. The method further comprises filling in the two sections of the shape with two different colors based on the person's mental functions. In an embodiment, blue represents iNtuitive, green represents Sensing, red represents Feeling, and black represents Thinking. The resulting icon is specific to the person's personality type and is a memorable visual reference. Symbolism is provided between the shapes, line orientation, colors, and the person's personality type preferences so that the person is better able to make the mental connection between the elements of the icon and their personal preferences for the personality type.

### DESCRIPTION OF THE DRAWINGS

For a more complete understanding of the present invention, and for further details and advantages thereof, reference is now made to the accompanying drawings, in which:

FIG. 1 is a flowchart of one embodiment of a method for creating an icon that visually represents personality type.

FIG. 2 is a graphical depiction of one embodiment of the method of FIG. 1 for creating an icon that visually represents personality type.

FIG. 3 is an illustration of the icons associated with the sixteen Myers-Briggs personality types.

### DETAILED DESCRIPTION

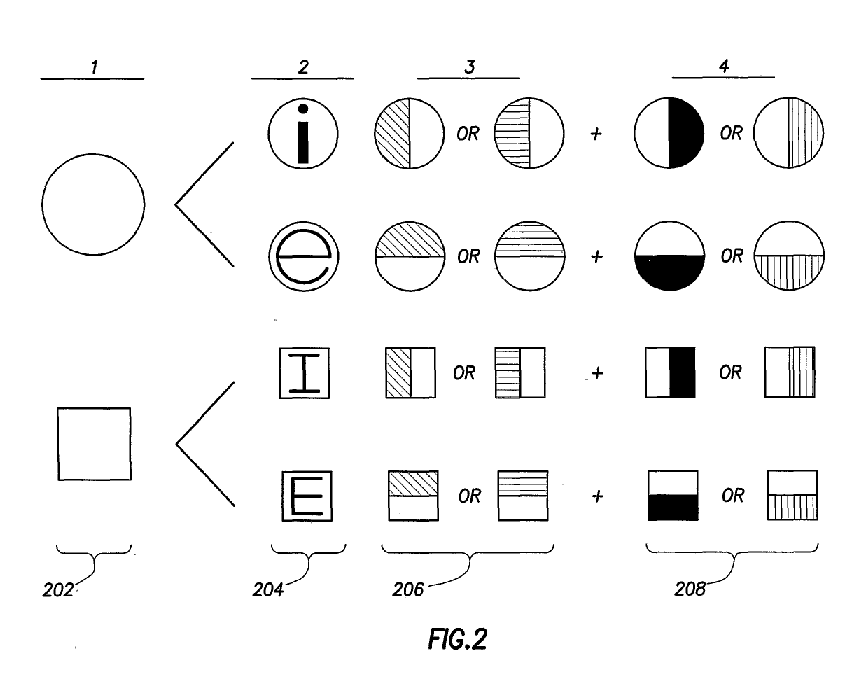

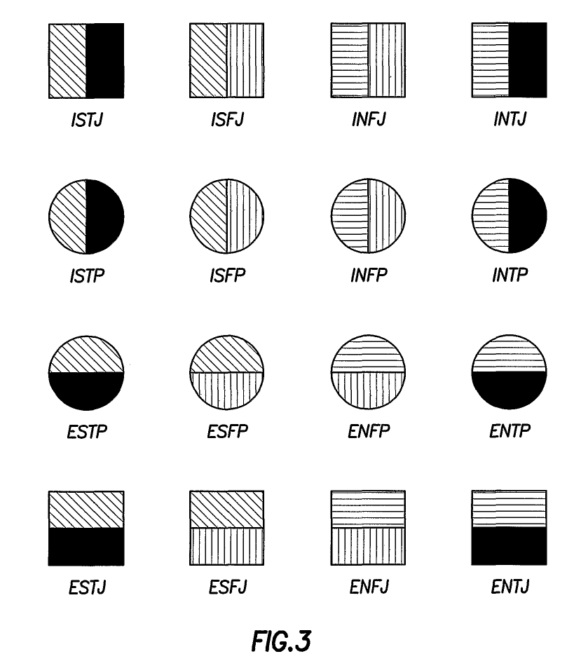

For purposes of describing the colors associated with one embodiment of a method for visually representing personality type, the drawings utilize the conventional color representation scheme identified in §608.02 of the Manual for Patent Examining Procedure (MPEP), a publication of the United States Patent and Trademark Office (USPTO). MPEP §608.02 states that the color blue is represented by horizontal shading, such as ≡. MPEP §608.02 states that the color green is represented by diagonal shading running from the upper left to the lower right, such as \\\. MPEP §608.02 also states that the color red is represented by vertical shading, such as [symbol] . Finally, MPEP §608.02 states that the color black is represented by solid shading, such as [symbol] . FIGS. 2 and 3 should be viewed with these color representations in mind.

Prior to creating an icon that visually represents personality type, a person must be aware of their personality type. A person can become aware of their personality type by completing a personality type indicator, assessment, or instrument. In one embodiment, the personality type indicator is the MBTI. The personality type indicator, assessment, or instrument may be administered by a certified or licensed professional or may be self-administered. Alternatively, the personality type may be determined without the use of a structured personality assessment type indicator, assessment, or instrument.

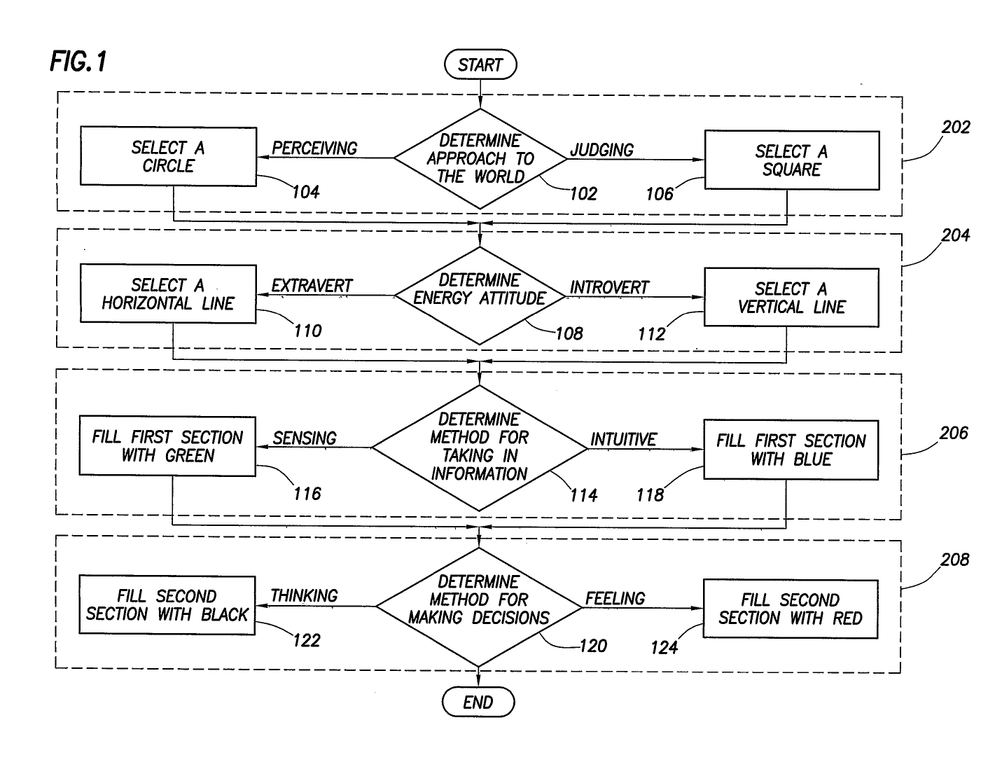

FIG. 1 and FIG. 2 illustrate one embodiment of a method for creating an icon that visually represents personality type. FIG. 1 is a flowchart of the logic associated with the method, and FIG. 2 is a graphical depiction of the method. FIG. 1 and FIG. 2 should be viewed together as they illustrate the same method for creating an icon that visually represents personality type. For example, Steps 202, 204, 206, and 208 are illustrated in both FIG. 1 and FIG. 2.

Referring now to the flowchart of FIG. 1, to create an icon that visually represents a person's personality type, the user must first determine the person's preferred attitudes as outlined in Steps 202 and 204, and then determine the person's preferred mental functions as outlined in Steps 206 and 208. FIG. 2 is a graphical depiction of the method of FIG. 1 for creating an icon that visually represents a person's personality type. The shape, line orientation, and colors are selected in Steps 202, 204, 206 and 208 to produce an icon that visually represents personality type. More specifically, the icon consists of a shape selected in Step 202, a line orientation selected in Step 204, and colors selected in Steps 206 and 208.

The first step of the method for visually representing personality type is to determine the person's attitudes. The attitudes describe how a person relates to the external world. There are two attitudes: approach to the world and energy attitude. A person has a preference for either a Judging or Perceiving approach to the world. A person also has a preference for either an Introverted or Extraverted energy attitude.

In Step 202, the person's approach to the world is determined and an appropriate shape is selected based on the determination. Thus, in decision block 102, a determination is made regarding the person's approach to the world. As previously mentioned, the term “approach to the world” refers to how people prefer to orient themselves with the world around them. A person can prefer a Perceiving approach to the world or a Judging approach to the world. If the person prefers a Perceiving approach to the world in decision block 102, then a circle is selected as the icon shape in block 104 and the method proceeds to Step 204. Otherwise, if the person prefers a Judging approach to the world in decision block 102, then a square is selected as the icon shape in block 106 and the method proceeds to Step 204.

If a circle shape is selected in block 104, the person has a preference towards a Perceiving approach to the world. People with a Perceiving approach to the world prefer to notice, experience, and understand their world. Words to associate with a Perceiving preference are: open-ended, openness, pending, flexible, laid-back, curious, speculative, spontaneous, adaptive, surprising, impulsive, prompted, evolving, and process-oriented. In an embodiment, the circle is the representative shape for the Perceiving preference because the circle symbolizes the letter “O” which can stand for Openness (to possibilities) or Open-ended (with respect to plans). Further, a circle has no beginning or end; and as such, it symbolizes the person's approach to learning: curiously going round and round a question or issue in order to uncover some new meaning. The unending nature of the circle also symbolizes the person's seemingly never-ending decision making process. The circle also resembles a ball, symbolizing the person's tendency to bounce from one observation, insight, or experience to another. Finally, a circle represents a divergent approach to problem solving: expanding the circle of opportunities and options in search of a solution. The aforementioned symbolism allows a person to easily associate the Perceiving preference with the shape of a circle. By understanding how a circle symbolizes a Perceiving preference, the person will be reminded of the Perceiving preference when they view the circular shape of their icon.

If a square shape is selected in block 106, the person has a preference towards a Judging approach to the world. People with a Judging approach to the world prefer to plan, organize, and manage their world. Words to associate with a Judging preference are: structured, closure, resolved, fixed, organized, decided, definitive, scheduled, established, planned, disciplined, prepared, systematic, and result-focused. In an embodiment, the square is the preferred shape for the Judging preference because there is an inherent order to a square: in drawing it, the person begins at a specific point and moves from corner to corner in distinct, sequential steps. People with a Judging preference take a similar approach to their daily routine. A square symbolizes structure and stability, words that also characterize a person with a Judging preference. In English, the words square, structure and stability all begin with the letter “S”. A square has straight edges that represent “lines in the sand” or boundaries that people with a Judging preference prefer not to cross. The outline of the square also represents a document, which symbolizes a Judging preference because people with a Judging preference frequently list their daily goals, plans, or tasks on paper. Finally, a square represents a convergent approach to problem solving: eliminating options until the person reaches a final solution. The aforementioned symbolism allows a person to easily associate the Judging preference with the shape of a square. By understanding how a square symbolizes a Judging preference, the person will be reminded of the Judging preference when they view the square shape of their icon.

While in some embodiments, a circle and a square are the representative shapes for the icon created by the method for visually representing personality type, the method may include other shapes as well. As used herein, the term “shape” refers to any two or three dimensional spatial form or contour. The shape is typically defined by at least one line or planar surface that is either straight or curved. Possible two-dimensional shapes include: a rectangle, triangle, parallelogram, trapezoid, ellipse, oval, pointed oval (i.e. football), egg or kidney shape, crescent, star, cross, rhombus, pentagon, hexagon, octagon, heptagon, decagon, dodecagon, or any other polygon. The shape may also be a portion of another shape, such as a sector or segment of a circle, or a sector of an annulus. Possible three-dimensional shapes include a cube, rectangular prism, pyramid, cone, cylinder, sphere, and torus. The shape may be a solid, hollow, and truncated embodiment of any of the aforementioned shapes. The shape may also be a hybrid, such as between a circle and a square, for example, based upon how strongly the person prefers the Judging or Perceiving preference. Persons of ordinary skill in the art are aware of shapes other than those described herein that may be used for the icon.

Cultural, regional, and personal variation may warrant selection of one of the other shapes. For example, other shapes, such as a cross, crescent, or star, may have more meaningful symbolism in different regions of the world. Alternatively, in countries that do not speak English, the selection of shapes may be reversed or different due to the fact that the foreign language symbolism attached to the shapes differs from the English language symbolism. Finally, a person may prefer another shape because the person has attached a personal symbolic meaning to a particular shape, such as Judging for a triangle. Regardless of the shape selected, the essence of the invention is that the person associates the shape with their particular personality type preference.

In Step 204, the person's energy attitude is determined, and a line orientation is selected based on the determination. Thus, in decision block 108, a determination is made regarding the person's energy attitude. As previously mentioned, the term “energy attitude” refers to the direction of focus of a person's awareness, attention, interest, and feelings. A person can prefer an Extraverted energy attitude or an Introverted energy attitude. If the person prefers an Extraverted energy attitude in decision block 108, then a horizontal line is placed inside the icon shape in block 110, and the method proceeds to Step 206. Otherwise, if the person prefers an Introverted energy attitude in decision block 108, then a vertical line is placed inside the icon shape in block 112, and the method proceeds to Step 206.

Thus, a vertically oriented line represents an Introverted energy attitude. Introverted people tend to focus their energy inward on their thoughts, feelings, ideas, and impressions. Introverts tend to pause to consider, assess, respond, inquire, reflect, study, reserve, have fewer and deeper relationships, have narrower and more in-depth interests, concentrate intensely, thoughtfully guard information, offer their opinions only when asked, be reserved or indifferent in a group, be private and reflective, and think before speaking. The letter “I” or “i” stands for an Introverted energy attitude, and in Step 204 of FIG. 2, the letter is shown placed within the shape selected in Step 202. In particular, FIG. 2 shows the lower case “i” placed within a circle and the upper case “I” placed in a square in Step 204. In each case, the letter “I” or “i” creates a vertical line within the shape. The vertical line symbolizes how energy flows in Introverted types: centered vertically and focused inward. Finally, the vertical line symbolizes a solitary individual standing. The aforementioned symbolism allows a person to easily associate the Introverted preference with a vertically oriented line. By understanding how a vertical line symbolizes an Introverted preference, the person will be reminded of the Introverted preference when they view the vertical line in their icon.

A horizontally oriented line represents an Extraverted energy attitude. Extraverted people focus their energy outward on the external world of people, events, activities, and things. Extraverted people tend to jump right in, engage, initiate, advocate, express, discuss, disclose, have a greater number of acquaintances, have broader and more varied interests, interact energetically, openly share information, state their unsolicited opinions, be gregarious and outgoing in a group, be enthusiastic and expressive, and speak to think or think out loud. The letter “E” or “e” stands for an Extraverted energy attitude, and in Step 204 of FIG. 2, the letter is shown placed in the shape selected in Step 202. In particular, FIG. 2 shows the lower case “e” placed within a circle and the upper case “E” placed in a square in Step 204. In each case, the letter “E” or “e” creates a horizontal line within the shape. The horizontal line symbolizes how energy flows in Extraverted types: laterally and outward toward other people and things. Finally, the horizontal line symbolizes a connection between two people. The aforementioned symbolism allows a person to easily associate the Extraverted preference with a horizontally oriented line. By understanding how a horizontal line symbolizes an Extraverted preference, the person will be reminded of the Extraverted preference when they view the horizontal line in their icon.

While in some embodiments, the line is a straight line oriented in either the vertical or horizontal direction, the present method includes other types and orientations of lines. As used herein, the term “line” refers to a visible or non-visible boundary or transition within the shape. For example, the line may contain at least one curvature, bend, or angle. Examples of such lines would be a sinusoidal line, a zigzag line, a squiggly line, and so forth. The thickness of the line may also be varied. The line may be a solid line or a broken, dashed, dotted, or phantom line. The line may be oriented in the horizontal, the vertical, or any diagonal direction. For example, the line could be oriented along the 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degree directions of a circle. The line may be visible or invisible. An example of an invisible line would be a transition in color or color properties between the first section and the second section. Thus, for example, if the first section is blue and the second section is red, the line would be the area where the red color abuts or is close to the blue color. Persons of ordinary skill in the art are aware of other types and orientations of lines. Regardless of the line orientation selected, the essence of the invention is that the person associates the line orientation with their particular personality type preference.

In Step 204, the line divides the shape into at least a first section and a second section. The upper or left section is the first section, and the lower or right section is the second section. The order of the sections is important because it symbolizes the order that people process information: first they take in the information, and then they use the information to make a decision. The first section and the second section may be reversed due to cultural, regional, or personal preferences. For example, in Middle Eastern countries that read and write right to left, it may be preferable to reverse the first section and the second section. The sections may also be reversed for personal preference, such as aesthetic preference. Persons of ordinary skill in the art are aware of reasons for changing the location of the first and second sections.

Another aspect of the method for creating an icon that visually represents a person's personality type is to determine the person's preferred mental functions. There are two basic mental functions: perceiving and judging, which incorporate four specific mental functions: Sensing, iNtuitive, Thinking, and Feeling. These mental functions relate to how a person processes information. The mental functions are classified into two categories: the person's method for taking in information (perceiving) and the person's method for making decisions (judging). A person has a preference for either a Sensing or iNtuitive method for taking in information. A person also has a preference for either a Thinking or a Feeling method for making decisions.

In Step 206, a determination is made regarding the person's method for taking in information, and the first section of the shape is filled with a representative color based on the determination. As previously mentioned, the term “method for taking in information” refers to the type of information a person tends to trust. A person can prefer a Sensing method for taking in information or an iNtuitive method for taking in information. In decision block 114, if a determination is made that the person prefers a Sensing method for taking in information, then in block 116, the first section of the icon shape is filled with the color green and the method proceeds to Step 208. Otherwise, in decision block 114, if the person prefers an iNtuitive method for taking in information, then in block 118, the first section of the icon shape is filled with the color blue, and the method proceeds to Step 208.

The color green represents a preference for a Sensing method for taking in information. A person with a Sensing preference tends to get to the specifics or “nuts and bolts” quickly, dive into the data and details, ask for only the facts, question what and how, define things by actual precise names, use their five senses, know what works and what does not work, experience something to understand it, learn by observing or doing, converse and proceed in a step-by-step approach, value usefulness and practicality, look for a tangible application, and be attracted to what is real. A person with a Sensing preference tends to be “down to earth” with a firm grasp of reality as their senses perceive it through sight, sound, smell, taste, and touch. The green color symbolizes the person seeing the green grass, hearing the sound of a lawnmower, smelling the freshly cut grass, feeling the grass under their bare feet. A person with a Sensing preference focuses on the details, and therefore the green color symbolizes how the person is sometimes unable to “see the forest for the trees.” The green color also symbolizes how a person with a Sensing preference would have in-depth factual knowledge, or a leafy description, of each tree within the forest. The aforementioned symbolism allows a person to easily associate the Sensing preference with the color green. By understanding how the color green symbolizes a Sensing preference, the person will be reminded of the Sensing preference when they view the green color in their icon.

The color blue represents a preference for an iNtuitive method for taking in information. A person with an iNtuitive preference tends to get the concept quickly, stay at a high level without much detail, ask for the big picture, question what if and why not, associate things, use a lot of pronouns, use their sixth sense to know, envision what could be or what should be, understand something before experiencing it, learn by imagining or theorizing, converse and proceed randomly taking a circuitous approach, value ingenuity and creativity, look for the intangible implication, and be attracted to what's possible. A person with a preference for an iNtuitive method for taking in information tends to generate blue-sky possibilities, as ideas come to them from out of the blue. A person with an iNtuitive preference may seem to have their head in the clouds, where the clouds are in the blue sky. People with an iNtuitive preference are often sought after because they possess a vision for the future that is a blueprint in their mind. A person with an iNtuitive preference tends to think or speak rapidly and randomly, as in a blue streak. Their passion for exploring the unknown can be symbolized in the saying “off we go into the wild blue yonder.” The aforementioned symbolism allows a person to easily associate the iNtuitive preference with the color blue. By understanding how the color blue symbolizes an iNtuitive preference, the person will be reminded of the iNtuitive preference when they view the blue color in their icon.

While in some embodiments, the colors green and blue are associated with the person's method for taking in information, it is contemplated that the method may utilize other colors to represent the person's method for taking in information. For example, other colors may be used to represent the Sensing and iNtuitive preferences based on regional, cultural, or personal variations. Other colors that may be used include: black, white, gray, red, orange, yellow, purple, and brown. Moreover, any combination of these colors may be used to produce other colors for the Sensing and iNtuitive methods for taking in information. Persons of ordinary skill in the art are aware of other colors that can be used to represent the Sensing and iNtuitive preferences. Regardless of the color selected, the essence of the method is that the person associates the color with their particular personality type preference.

Referring now to Step 208, a determination is made regarding the person's method for making decisions, and the second section of the shape is filled with a representative color based on the determination. As previously mentioned, the term “method for making decisions” refers to how a person tends to resolve issues in their mind. A person can prefer a Thinking or a Feeling method for making decisions. In decision block 120, if a determination is made that the person prefers a Thinking method for making decisions, then in block 122 the second section of the icon shape is filled with the color black and the method ends. Otherwise, in decision block 120, if the person prefers a Feeling method for making decisions, then in block 124 the second section of the icon shape is filled with the color red and the method ends.

The color black represents a preference for a Thinking method for making decisions. The term “Thinking” as used herein refers to a person that uses an analytical, objective approach to problem solving and issue resolution. A person with a Thinking preference tends to detach him/herself from the issue or problem and use logical, objective objective analysis to resolve the issue or problem. A person with a Thinking preference uses this method even when dealing with personal issues or problems. Words to associate with a Thinking preference are: head, objective, principle, logic, reason, requirement, priority, law and evidence, cause and effect, consequence, feasible, and task. A person with a Thinking preference tends to analyze, organize, prioritize, categorize, question, challenge, critique, evaluate, debate, and confront, and such people are typically described as candid, direct, firm, reasonable, just, equitable, detached, and aloof. Black symbolizes these traits because it represents “black and white” thinking: seeing issues as either-or choices and categories. Black also represents the black robes worn by judges in the courtroom who weigh the law and the evidence. Black also symbolizes the blind scales of justice, administering justice without passion or prejudice towards the parties. The contrast of black with white also symbolizes how a person with a Thinking preference tends to see things as right or wrong, on or off, true or false, benefit and cost, pro or con, and so forth. The aforementioned symbolism allows a person to easily associate the Thinking preference with the color black. By understanding how the color black symbolizes a Thinking preference, the person will be reminded of the Thinking preference when they view the black color in their icon.

The color red represents a preference for a Feeling method for making decisions. As used herein, the term “Feeling” refers to a person that uses subjective criteria to decide a problem or resolve an issue. A person with a Feeling preference tends to involve him/herself in the issue or problem and weigh the subjective considerations in the decision-making process. Words to associate with a Feeling preference are: heart, subjective, people, values, passion, needs, concerns, intent and circumstances, worth, importance, connections, desirable, and relationships. A person with a Feeling preference tends to empathize, harmonize, humanize, personalize, affirm, accept, appreciate, validate, converse, and confer, and such persons are typically described as tactful, diplomatic, persuasive, compassionate, merciful, humane, involved, and agreeable. The color red symbolizes how a person with a Feeling preference reaches conclusions with their heart. Red also symbolizes passion or warmth that a person with a Feeling preference exhibits. The aforementioned symbolism allows a person to easily associate the Feeling preference with the color red. By understanding how the color red symbolizes a Feeling preference, the person will be reminded of the Feeling preference when they view the red color in their icon.

While in some embodiments, the colors black and red are associated with the person's method for making decisions, it is contemplated that the method may utilize other colors to represent the person's method for making decisions. For example, other colors may be used to represent the Thinking and Feeling preferences based on regional, cultural, or personal variations. Other colors that may be used include: white, gray, orange, yellow, green, blue, purple, and brown. Moreover, any combination of these colors may be used to produce other colors to represent Thinking and Feeling. One example is the use of a black and white checkered pattern in lieu of solid black for the Thinking preference. The black and white checkered pattern symbolizes black and white thought. Persons of ordinary skill in the art are aware of other colors that can be used for the Thinking and Feeling preferences. Regardless of the color selected, the essence of the invention is that the person associates the color with their particular personality type preference.

While FIG. 1 and FIG. 2 illustrate one embodiment of a method for creating an icon that visually represents a person's personality type, such an icon may be created by another method. For example, the order of the Steps 202, 204, 206 and 208 can be rearranged. Persons of ordinary skill in the art are aware of methods for creating an icon that visually represents personality type other than the method depicted in FIG. 1 and FIG. 2.

FIG. 3 is an illustration of the icons associated with the sixteen Myers-Briggs personality types. The top row represents the ISTJ, ISFJ, INFJ, and INTJ personality types. types. The second row represents the ISTP, ISFP, INFP, and INTP personality types. The third row represents the ESTP, ESFP, ENFP, and ENTP. Finally, the bottom row represents the ESTJ, ESFJ, ENFJ, and ENTJ personality types.

The method also includes alternative approaches for using the colors discussed herein. Color properties, such as hue, contrast, and intensity, may be varied for at least one color for aesthetic reasons or to convey information regarding the person's personality type. For example, instead of using two separate colors to, symbolize the two mental function preferences, it may be desirable to use one color faded in a certain direction, such as top to bottom or left to right. It may also be preferable to change the intensity of the color depending on how strongly the person prefers the particular attitude or mental function. Persons of ordinary skill in the art are aware of alternative methods for using the colors discussed herein.

The method also includes alternative approaches for creating the sections discussed herein. If a single color is used within the shape, the line may be the boundary between areas with different color properties, such as an area with dark hue and an area with light hue. The two sections may also be created by fading at least one color from high intensity to medium intensity, from high intensity to low intensity, or from medium intensity to low intensity. The sections may also be created by blending two colors together in a transition area, such as from blue to red, with purple as the transition area. Persons of ordinary skill in the art are aware of other methods for creating the sections described herein.

While the method may be applied to the MBTI as described herein, it is contemplated that the method may be applied to other types of personality type indicators, assessments, or instruments. As used herein, the term “personality type” refers to a quantitative, categorized, or otherwise objective measurement of a person's personality, intelligence, psychological, or physiological state. The present method may be adapted to create icons that visually represent a personality type, intelligence level, or psychological state based on one of the following personality type indicators, assessments, or instruments; for example; Murphy-Meisgeier Type Indicator for Children (MMTIC), DiSC Personal Profile, Birkman Personality Assessment, Enneagram Tests, Big Five Tests, Personality Disorder Test, Compatibility Test, Career Test, Eysenck Personality Test, Word Association Test, Keirsey Temperament Sorter, Wechsler Adult Intelligence Scale III, Rorschach Test, Stanford-Binet Intelligence Scale, Piers-Harris Children's Self Concept Scale, Swassing-Barbie Modality Index, Learning Efficiency Test II, Harter Self Perception Profile, SCL-90-R, Developmental Test of Visual Motor Integration, and Reynolds Adolescent Depression Scale.

In another aspect of the method for visually representing personality type, the icons created by the method represent the eight (8) Jungian functions. In more detail, as previously described, there are two (2) basic mental functions: Perceiving and Judging, which incorporate four (4) specific mental functions: Sensing, iNtuitive, Thinking, and Feeling. Thus, a person's personality has two parts (which the icons reveal): a Perceiving part and a Judging part; and the eight (8) Jungian functions are Extraverted and Introverted forms of the mental functions Sensing, iNtuitive, Feeling, and Thinking.

The two-section icon that represents a person's personality type also represents two of the Jungian functions: a dominant function and an auxiliary function. The icon may be separated into its constituent sections, which is either a half-circle (moon) shape (i.e. one half of the circle symbolizing the Perceiving preference) or a rectangle (i.e. one half of the square symbolizing the Judging preference). The moon and rectangle constituent shapes of the icon contain the colors described above to represent the Sensing, iNtuitive, Feeling, and Thinking mental functions. Thus, the eight (8) Jungian functions may be represented as follows: Extraverted Sensing represented by a green moon, Introverted Sensing represented by a green rectangle, Extraverted iNtuitive represented by a blue moon, Introverted iNtuitive represented by a blue rectangle, Extraverted Feeling represented a red moon, Introverted Feeling represented by a red rectangle, Extraverted Thinking represented by a black moon, and Introverted Thinking represented by a black rectangle. Thus, the two-section icon produced by the present method is a complete visual representation of the two Jungian functions that make up the person's personality type. According to Jung's theory, a person will Extravert one mental function (represented by one section of the person's icon) and Introvert the other. As such, if the person is an Introvert, the function that person Introverts is dominant, and the function that person Extraverts is auxiliary. The opposite is true if the person is an Extravert. For example, the ENFP personality type is represented by a circular icon with a horizontal line forming an upper section and a lower section that are filled with the colors blue and red, respectively. This person is an Extravert, so they would Extravert iNtuitive (blue moon) as their dominant function, and introvert Feeling (red moon) as their auxiliary function. Thus, by separating their personal icon into its constituent sections, a person can determine their two Jungian functions. Knowledge of a person's dominant and auxiliary Jungian functions leads to a better understanding of the person's strengths, challenges, and organizational talents.

The methods contained herein may be presented to a group of people within a corporate environment. The methods may optionally be published for the audience. In an embodiment, the presenter explains the four-step process disclosed herein and allows each audience member to create a personal icon that visually represents their personality type. These icons are useful in a corporate environment because they allow people to remember their personality type and prevent confusion between the different personality types. For example, when a person sees the coding INTJ, they are generally not able to recall the meaning or significance of the letters. However, when the same person sees the 4^{th} icon in the top row of FIG. 3 (i.e. the icon for the personality type INTJ), they associate the square with order, structure, and boundaries and recall that they have a Judging preference, they associate the vertical line with solitude and inner reflection and recall that they have an Introverted preference, they associate the blue color with blue skies and blueprints for the future and recall that they have an iNtuitive preference, and they associate the black color with law and evidence and a judge's robe and recall that they have a Thinking preference. Thus, the method for visually representing personality type is an improvement over the prior art methods for describing personality types.

The icon for visually representing personality type can be used for a variety of purposes. The icon can be printed onto a label or pin and worn on the person's clothing. The icon can also be printed on a label or piece of paper and displayed as a sign to communicate the person's personality type to other people. The icon can also be used in many different electronic formats, such as on a webpage, in an electronic document, or as an attachment to an email, for example. The icon can also be affixed to the inside or outside of the person's personnel file so that the person's personality type can be easily referenced. Such indexing is useful to managers and group leaders when selecting team members for a group. For example, if the leader wants group members with different personality types, it is easier for the leader to select people based on shapes, colors, and line orientations rather than a four letter coded format. Similarly, if the leader wants a group of people with Introverted, Judging, iNtuitive, and Thinking preferences, he can select people with square icons with a vertical line and blue and black colors. It is much easier to recognize the icon than the INTJ coding. Persons of ordinary skill in the art are aware of other uses for the icons disclosed herein.

While a number of embodiments of the method have been shown and described herein, modifications thereof may be made by one skilled in the art without departing from the spirit and the teachings of the invention. The embodiments described herein are exemplary only, and are not intended to be limiting. Many variations, combinations, and modifications of the in method disclosed herein are possible and are within the scope of the invention. Accordingly, the scope of protection is not limited by the description set out above, but is defined by the claims which follow, that scope including all equivalence of the subject matter of the claims.

What is claimed is:

1. An icon for indicating a person's personality type comprising: a shape and a color.

2. The icon of claim 1 further comprising:
a line oriented to divide the shape into a first section and a second section;
wherein the color is a first color and the icon further comprises a second color; and
wherein the first section is filled with the first color and the second section is filled with the second color.

3. The icon of claim 2 wherein the shape represents the person's approach to the world.

4. The icon of claim 2 wherein the orientation of the line represents the person's energy attitude.

5. The icon of claim 2 wherein the first color represents the person's method of taking in information.

6. The icon of claim 2 wherein the second color represents the person's method of making decisions.

7. The icon of claim 2 wherein the shape is selected from a group consisting of: a square and a circle.

8. The icon of claim 2 wherein the orientation of the line is selected from a group consisting of: substantially horizontal and substantially vertical.

9. The icon of claim 2 wherein the first color is selected from a group consisting of: green and blue.

10. The icon of claim 2 wherein the second color is selected from a group consisting of: red and black.

11. The icon of claim 2 wherein the first section is above or to the left of the line.

12. The icon of claim 2 wherein the second section is below or to the right of the line.

13. The icon of claim 2 wherein the line is a straight line.

14. The icon of claim 2 wherein the line contains at least one curvature or angle.

15. A publication wherein the icon of claim 2 is used to indicate the person's personality type.

16. A presentation wherein the icon of claim 2 is used to indicate the person's personality type.

17. An aid for remembering the person's Myers-Briggs Type Indicator comprising the icon of claim 2.

18. The aid of claim 17 wherein a square represents a Judging preference and a circle represents a Perceiving preference; wherein a substantially horizontal line represents an Extraverted preference and a substantially vertical line represents an Introverted preference; wherein green represents a Sensing preference and blue represents an iNtuitive preference; and wherein black represents a Thinking preference and red represents a Feeling preference.

19. An icon for indicating a person's personality type, the icon comprising: a shape comprising a plurality of sections; and a color within at least one of the sections.

20. The icon of claim 19 further comprising a color within each section.

21. The icon of claim 19 wherein the color is a first color and the icon further comprises a second color; and wherein the first section is filled with the first color and the second section is filled with the second color.

22. The icon of claim 21 wherein the first color is selected from a group consisting of: green and blue.

23. The icon of claim 21 wherein the second color is selected from a group consisting of: red and black.

24. The icon of claim 21 wherein the first color represents how the person takes in information.

25. The icon of claim 21 wherein the second color represents how the person makes decisions.

26. The icon of claim 19 further comprising: a line oriented between two of the sections.

27. The icon of claim 26 wherein the orientation of the line is selected from a group consisting of: substantially horizontal and substantially vertical.

28. The icon of claim 26 wherein one of the sections is above or to the left of the line.

29. The icon of claim 26 wherein one of the sections is below or to the right of the line.

30. The icon of claim 26 wherein the line is a straight line.

31. The icon of claim 26 wherein the line contains at least one curvature or angle.

32. The icon of claim 26 wherein the orientation of the line represents the person's energy attitude.

33. The icon of claim 19 wherein the shape represents the person's approach to the world.

34. The icon of claim 19 wherein the shape is selected from a group consisting of: a square and a circle.

35. A publication wherein the icon of claim 19 is used to indicate the person's personality type.

36. A presentation wherein the icon of claim 19 is used to indicate the person's personality type.

37. An aid for remembering the person's Myers-Briggs Type Indicator comprising the icon of claim 26.

38. The aid of claim 37 wherein a square represents a Judging preference and a circle represents a Perceiving preference; wherein a substantially horizontal line represents an Extraverted preference and a substantially vertical line represents an Introverted preference; wherein green represents a Sensing preference and blue represents an iNtuitive preference; and wherein black represents a Thinking preference and red represents a Feeling preference.

39. A method for creating an icon that visually represents a person's personality type, the method comprising:
selecting a shape;
selecting an orientation of a line within the shape, the line creating at least one section within the shape; and
selecting at least one color to at least partially fill the section.

40. The method of claim 39 wherein the at least one color is non-uniform within the shape.

41. The method of claim 39 wherein the at least one color is a first color and a second color; and wherein the at least one section is a first section filled with the first color and a second section is filled with the second color.

42. The method of claim 41 wherein the first color is selected from a group consisting of: green and blue.

43. The method of claim 41 wherein the second color is selected from a group consisting of: red and black.

44. The method of claim 41 wherein the first color represents how the person takes in information.

45. The method of claim 41 wherein the second color represents how the person makes decisions.

46. The method of claim 39 wherein the orientation of the line is selected from a group consisting of: substantially horizontal and substantially vertical.

47. The method of claim 41 wherein the first color is above or to the left of the line.

48. The method of claim 41 wherein the second color is below or to the right of the line.

49. The method of claim 39 wherein the line is a straight line.

50. The method of claim 39 wherein the line contains at least one curvature or angle.

51. The method of claim 39 wherein the shape represents the person's approach to the world.

52. The method of claim 39 wherein the orientation of the line represents the person's energy attitude.

53. The method of claim 39 wherein the shape is selected from a group consisting of: a square and a circle.

54. A publication wherein the method of claim 39 is used to create an icon that visually represents the person's personality type.

55. A presentation wherein the method of claim 39 is used to create an icon that visually represents the person's personality type.

56. A method for creating an aid for remembering the person's Myers-Briggs Type Indicator comprising the method of claim 39.

57. The method of claim 56 wherein a square represents a Judging preference and a circle represents a Perceiving preference; wherein a substantially horizontal line represents an Extraverted preference and a substantially vertical line represents an Introverted preference; wherein green represents a Sensing preference and blue represents an iNtuitive preference; and wherein black represents a Thinking preference and red represents a Feeling preference.
